(19) United States
(12) Patent Application Publication
(10) Pub. No.: US 2019/0020127 A1
(43) Pub. Date: Jan. 17, 2019

(54) INSULATION DISPLACEMENT TERMINATION (IDT) FOR MASS TERMINATION OF MULTIPLE ELECTRICAL WIREGAUGE SIZES AND IN TERMINATION OF MULTIPLE WIRE GAUGE SIZES TO STRIP TERMINAL PRODUCTS

(71) Applicant: John D Tillotson, JR., Scottsdale, AZ (US)

(72) Inventor: John D Tillotson, JR., Scottsdale, AZ (US)

(21) Appl. No.: 16/022,496

(22) Filed: Jun. 28, 2018

Related U.S. Application Data
(60) Provisional application No. 62/532,352, filed on Jul. 13, 2017.

(51) Int. Cl. H01R 4/2466; H01R 4/2454; H01R 4/2462

(52) U.S. Cl. CPC H01R 4/2466; H01R 4/2462; H01R 4/2454

(57) ABSTRACT

An insulation displacement connector (IDC) includes clamping terminals or contacts which make two redundant contacts into the wires instated into them. The inventive contact comprises a flat strip section, four J-shaped cantilevers each having a straight section and an arcuate section, with a portion of each of said straight section attached to the flat strip section, and the cantilevers arranged into two pairs each having two arcuate sections curving towards each other to form a pincer section. The two pincer pairs face toward each other on the strip. A wire received into both pincer pairs is held securely because any tension applied to the wire forced at least one pincer set to clamp together harder on the wire. The inventive contacts reside in an insulator housing of an insulation displacement terminal (IDT) connector assembly which can accept wires of mixed sizes.

### PRIORITY: CROSS-REFERENCE TO THE RELATED APPLICATION

This non-provisional utility patent application claims the benefit of and priority to U.S. Provisional Application 62/532,352 “Insulation Displacement Termination (IDT) Design for Mass Termination of Multiple Electrical Wire Gauge Sizes in IDT Multiple Position Electrical Connector Products,” filed Jul. 13, 2017.

The entire content of U.S. Provisional Application 62/532,352 “Insulation Displacement Termination (IDT) Design for Mass Termination of Multiple Electrical Wire Gauge Sizes in IDT Multiple Position Electrical Connector Products,” filed Jul. 13, 2017, is hereby incorporated into this application document by reference.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever

### FIELD

The invention generally relates to wire harness termination of multiple wires in a multiple position connector securely connecting sets of wires having more than one gauge size and in the termination of single terminals that are manufactured in continuous strip form from high speed progressive die apparatus.

### BACKGROUND OF THE INVENTION

Insulation Displacement Termination (IDT) connectors allow mass termination of multiple wires in a multiple position connector product. By having terminals which cut through a wire jacket to make an electrical contact with the central solid conductor or group of strands in a wire, IDT connectors eliminate any required preparation of the wire end before the wire gets attached to the connector. IDT connectors in wire harnesses eliminate many wire assembly tasks such as insulation stripping, crimping to individual terminals or contacts, or soldering. IDT connectors are especially convenient for terminating wires which have been grouped in advance or manufactured as a unitary group, such as ribbon cable.

IDT connectors for typical cable harnesses are designed with an insulator housing holding one or more linear arrays of IDT terminals, and a backing plate or clip. The wires are lain en masse over their proper terminals and the backing plate (if included in the design) is positioned above the wires to form a sandwich. A press operation crushes the sandwich together and the backing plate forces the wires to become impaled upon the IDT terminals. The terminals pierce the wire insulator material, and encounter the central metal conductors. Common conductor materials include copper, aluminum, and brass and bronze alloys. Precious metals such as gold silver and platinum are also used but much more rarely. Thus most metal conductors received into wire harness cable end connectors will be non-precious metals which have accrued an external oxide film from contact with Earth atmosphere at some point in the wire manufacturing process.

For the best electrical interconnection, the oxide films on the wire strands and on the terminals must be displaced to expose fresh metal and to forge fresh metal to fresh metal contacts. This displacement may occur by scraping of the wire by the terminal during the crush process, or by deformation of the wire strands so that the oxide coating is stretched apart and fragmented to reveal fresh metal underneath. Yet even after a successful electrical interconnection is made, a minimum crushing force must be maintained over the life of the wire harness. Oxide films will grow on exposed fresh metal at the contact interface and can propagate over time to wedge apart previously bonded conductors, resulting in increased contact resistance, performance decay, loss of signal integrity, electrical noise, and intermittent interruption of electricity intended to pass through to the device to which the cable is attached. Thus during and after assembly, sufficient pinching force must be developed and maintained by each IDT terminal to create and preserve “gas tight” metal to metal contact and durable and reliable electrical performance. Many previous designs fail to maintain good pinching force over a service lifetime, especially in applications where vibrations or thermal or mechanical shock cause individual conductive strands to drift from their originally installed positions.

Wire harnesses are also often used to electrically interconnect two pieces of equipment that move with respect to each other, or which are subject to mechanical shock or vibration, or temperature extremes or thermal shocks. In these and other application environments, IDT connectors must also resist a wire being pulled out of a terminal.

It is sometimes desired to supply an electrical device with high power to some of its subassemblies and low power to others. A common arrangement supplies a small number of larger, heavy-duty wires for motive power, solenoids, or heating, while a larger number of smaller, finer wires or ribbon cable is used for parallel data, digital signaling or digital control of the device. Some devices can require several intermediate sizes of wiring.

Conventional IDT designs allow only for connecting multiple wires of only one common wire gauge size, i.e, the same wire size, at a time. A common design for IDT contacts is the tuning-fork contact which has a pair of blades united at their base, so that an insulated wire inserted between the blades gets its insulation skived off (or pared off) on both sides. The gap between the two blades of the tuning fork forms a deep “V” which forces the conductive strands of a multiple strand wire together to form a plurality of gas-tight interconnections, However, a tuning fork contact of a given size can only successfully grab a narrow range of wire sizes, and if a wide range of wire sizes are to be connected in the same headshell then such a headshell must be populated with a contacts of a number of different designs, each capable of handling its own narrow range of wire size, because if an oversize wire is inserted into the typical tuning fork or v-notch contact design, either the tuning fork deflects too much and loses its pinching force due to plastic deformation of its blades, or one or more strands of the inserted wire become cut clean off or shorn during the installation. The result is an unreliable electrical contact susceptible to long term degradation of electrical properties or excessive contact resistance due to an insufficient number of strands having made good electrical bonds with the contact.

The manufacturing of wire harness assemblies is a very labor intensive process is made even more complicated when for multiple wire sizes within a cable harness, each size must use its own dedicated cable end connectors. For example, the spring loaded contacts of U.S. Pat. No. 9,543,665 to Sabo require individual wires to be inserted into keyhole-shaped slots shown in FIG. 2A of that document. Most IDC contact designs use a vertical plate with a slot of a predetermined width, as seen in FIGS. 1B and 1C of Sabo. Plates having a slot, or even an effectively serrated slot as in Sabo work best for connecting to solid wire. The initial compression afforded by a vertical plate and slot design deteriorates when multiple-strand wires are inserted. Vibration, tension, and other environmental conditions can allow the individual strands of wire to rearrange themselves over time, causing loss of contact force or pinching force onto these conductive elements, resulting in loss of electrical integrity of the connection.

In addition to being primarily suited only for solid wire connections, each slotted plate design can only handle a narrow range of wire size. Terminating multiple wire sizes into a single connector headshell usually requires a mix of contact styles each dedicated to one size or style of wire to be terminated. U.S. Pat. No. 5,890,924 to Endo et al, and U.S. Pat. No. 7,995,116 to Bishop have slotted vertical plate contacts that illustrate these limitations. Also, vertical plate and slot contacts cannot dynamically maintain contact normal force if the internal conductors of a multi-strand wire rearrange themselves in response to initially established pinch forces. This is also a limitation of terminals having two separate, substantially vertical and rigid plates receiving a wire inserted into a slot or gap between these features. An example of such a slot is seen between items 32 and 34 in FIG. 1 of U.S. Pat. No. 4,385,794 to Lucius. The bent plate features act the same as a vertical plate with a vertical slot. This limitation is also present in U.S. Pat. No. 4,648,679 to Pelezarski.

Where several connections must be made at a particular site, the opportunity for error, mis-wiring, or damage increases with the number of attachments to be made. It would an improvement in labor costs and design simplicity to be able to offer an IDT interconnection system which could handle mixed wire sizes in a single headshell or cable end connector.

Lastly, cable headshell assembly can be simplified if all IDT terminals in a cable end can receive their designated wires from a single direction, so that a simple press having only a flat plate descending from above can be used to successfully and reliable install each wire into its designated terminal in a single operation. This simplified press tool is called “flat rock termination tooling” and it avoids the expenses of dedicated tooling for particular connectors and lost time in reconfiguring a press once a batch of one design is completed and the next scheduled batch requires a changeover to its own application specific tooling plates and set-up gauges.

### BRIEF SUMMARY OF THE INVENTION

From the aforementioned background it is understood that man objectives exist. A primary objective of the invention is to provide IDT terminals, that is, terminals of a design capable of incising or piercing through wire or cable insulators and making a permanent and reliable electrical connection with the central conductor or conductors in each wire or cable. A corollary objective is that the wires, cable or ribbon cable or the like require only minimal preparation or ideally no preparation before such a connection can be made. For example, stripping of exterior insulators should not be required and preparatory tinning exposed conductors or capillary induction of solder into trimmed wire ends should not be required. Another corollary objective is that a good electrical connector can be established without requiring treatments to the wires for removal of oxide films or corrosion products accrued during typical storage environments or handling conditions to be reasonably expected in the cable harness assembly industry.

Another objective of the invention is that each insulation displacement connection thus made remains electrically reliable over a reasonable service life in an environment of temperature extremes and fluctuations, mechanical shocks and vibration, and typical levels of corrosiveness found in atmosphere, industrial environments, or other reasonably foreseeable environmental conditions. A corollary objective is that the insulation displacement terminal can retain a connected wire or cable while resisting reasonable levels of tension, bending, and twisting forces. The terminal should resist pull-out of a connected or inserted wire.

Another objective of the invention is to provide a capability of connecting to sets of mixed wire gauge sizes in one IDT mass termination operation. This capability would provide multiple opportunities for lowering the cost of wire harness assembly manufacturing, such as by shortened production time, reduced in-process inventory time, reduced scrap, and to produce completed assemblies in the smallest manufacturing space possible. By replacing a design having several connectors each having their own narrow range of wire size with a smaller number of connectors each handling a large mix of wire sizes or even consolidating into a single mixed-size connector, assembly complexity and opportunities for error or damage are reduced.

Furthermore, the necessity of populating a number of different contact designs into a single headshell brings with it excess costs and complexities of managing a plurality contact designs as discrete part numbers and ensuring that for each connector head shell, the right contacts are positioned at their correct sites and the correct wires are installed into their designated contacts. It would be preferable if a single contact design could handle the full range of wire sizes to be installed into a connector headshell, because of the simplifications and savings available by reducing the number of different part numbers in each connector headshell assembly. Especially in the automotive industry, the regulatory and documentary burdens of quality control to the lot and batch level for each part number in control can be reduced. Great savings of time, repeated validation testing, traceability and statistical process control records can be reduced by reducing the number of part numbers called out in a particular assembly. Thus it is an additional objective of the invention to provide a single contact design capable of handling the widest range of wire sizes possible.

Various devices are currently available which attempt to address these challenges, although they may at best meet only one or two aspects of the totality of the requirements.

### BRIEF DESCRIPTION OF THE DRAWINGS

A further understanding of the nature and advantages of particular embodiments may be realized by reference to the remaining portions of the specification and the drawings. Similar reference numerals are used to refer to similar components.

FIG. 1 shows a typical IDT terminator applicator machine [1] in its context of a wire harness manufacturing station.

FIGS. 2a through 2g show common types of terminal carrier strips or pilot strips used to furnish a series of terminals for assembly into a connector.

FIGS. 2i through show terminals using the inventive IDT wire cleat, and having various types of terminal ends used for connecting loose wires to binding terminal screws and the like and for installing into cable end head-shells and connector assemblies.

FIGS. 3a through 3d show the features of the inventive IDT wire cleat, with FIG. 3d being a cross-section taken at a section line x-x defined in FIG. 3a.

FIGS. 4a through 4d show optional board-stake and solder tail embodiments of the IDT wire cleat terminal all in accordance with the invention.

FIG. 4e shows a leaf spring contact incorporating the inventive IDT wire cleat terminal section.

FIGS. 5a and 5b show a top and side view of an alternate embodiment of the inventive IDT wire cleat terminal section of a contact or terminal.

FIGS. 6a, 6b, and 6c illustrate a stiffening pocket or rib embossed or indented into an angle or channel portion of a stamped and formed contact in accordance with the invention.

FIGS. 7a through 7d show the progressive steps in forming the inventive IDT portion of a contact or terminal in accordance with the invention.

FIG. 8a shows an alternate embodiment of a wire cleat IDT terminal in accordance with the invention.

FIG. 8b shows an inventive IDT terminal in accordance with the invention which is complementary to the pin terminal shown in FIG. 8a.

FIG. 8c shows a split pin terminal and a first wire installed into the inventive IDT section of the terminal, mated to a duck-bill terminal with a wire installed into the inventive IDT section of the terminal.

FIGS. 8d and 8e show a top view and end view of a male cable headshell including wires mated to the inventive IDT pin terminals.

FIGS. 8f and 8g show a top view and end view of a male cable headshell including wires [73] mated to the inventive IDT pin terminals.

FIG. 9 shows a set of the inventive IDT wire cleats, all of the same size, but each receiving and connecting to a wire of a of a different size.

FIG. 10 shows a new means of wire installation into the inventive IDT wire cleats, using a wheel.

### DETAILED DESCRIPTION OF THE INVENTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this specification, the term “means for . . . ” as used herein including the claims, is to be interpreted according to 35 USC 112 paragraph 6.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Also in this specification the word “wire” may be used interchangeably with the word “cable” when meaning a single strand structure comprising a solid or a stranded central conductor surrounded by an insulating coating or a jacket. A “wire” in this specification may have a solid central conductor or a braided or served strand built up from a plurality of solid conductors. Some wires have a built-up core of multiple conductors, with each individually coated a solder or a brazing material which is heated to bond the group to act as a unitary conductor. “Ribbon cable” is comprised of a linear array of individual wires having conjoined insulators to form a flat membrane or strip.

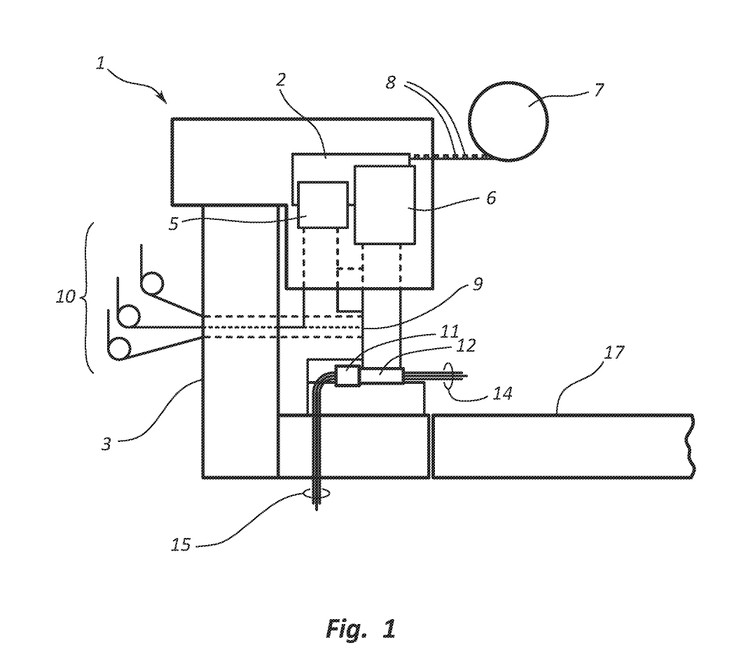

FIG. 1 shows a typical IDT terminator applicator machine [1] in its context of a wire harness manufacturing station. The machine includes a motor [2] typically including or operatively connected to a flywheel or other rotating mass which stores and provides rotational inertia during an operating cycle.

Application tooling specific for the cable to be made provides an intermittent wire holding and feeding system [5] and specific tooling [6] to “wire cut and stuff” flying leads, braided cable, ribbon cable or other forms of electrical conductors typically provided in bulk spools. Connector contacts or terminals [8] can also be provided in bulk spools [7.]

Spools of bulk wires of various gauges and colors, or fairlead pulleys [10] guiding wire from bulk storage spools, skeins, or boxes are passed through a side wall [3] or back wall of the machine. Because cutting, trimming and terminating operations often fling clipped. wire ends and other debris at random, the side wall or back wall helps confine such debris to the vicinity of the assembly station and prevents foreign matter from contaminating the bulk cable sources. The application tooling mounted on the side wall shown is designed for mass terminating wires [10] after a manual multiple of these wires which are individually dressed around form board pins located on form board [17] to their end location positions (not shown.) The mass termination cycle in this figure will initiate when all wires pulled through wall [3] have reached their final end positions.

In some machinery designs, a clamping system aligns a set of terminals to an arrangement of wires taken from the bulk supply [10] and in a single action of compression the contacts are electrically bonded to and crimped into their terminals while the wire simultaneously parted off its bulk supply, leaving a set of trimmed ends [9] available to begin building the other end of the next cable harness [14] to be made. The trimmed ends [9] remain clamped in the shearing tools which effect the cutoff. The previously terminated wires are pressed into a headshell or cable end connector [12] by the excursion or stroke of the machine, and the cycle is repeated for the next cable to be built.

Another labor saving step is to assemble the wires into their cable end connector while it is mated to a complementary connector [11] which holds signal lines [15] so that diagnostic tests can verify that acceptable connections have been made and even test other components incorporated into the cable at this point in the assembly process. For example some cables include in-line active or passive electronic components such as dropping resistors or impedance matching circuits, and these can be energized and analyzed for correct function. Non-conforming material can be detected and excluded from the assembly process for rework, salvage, or scrap.

Cable terminating tooling as described above is usually located at the periphery of a peg board template or wire harness assembly platform [17] that allows an assembler to pull lengths of wire from bulk sources, arrange the wires and cables into a harness, and then assemble connectors and head-shells onto the various ends of the harness using the terminating tool. As the wires are arranged in a cable end connector or heads ell having IDT contacts, all the wires can be mass terminated in one operation.

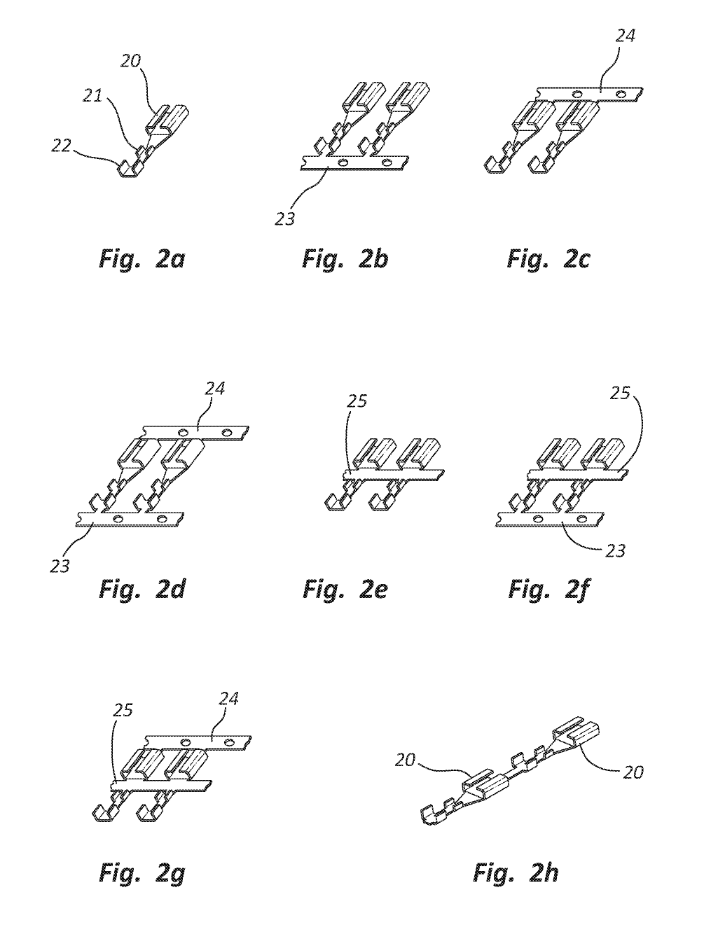

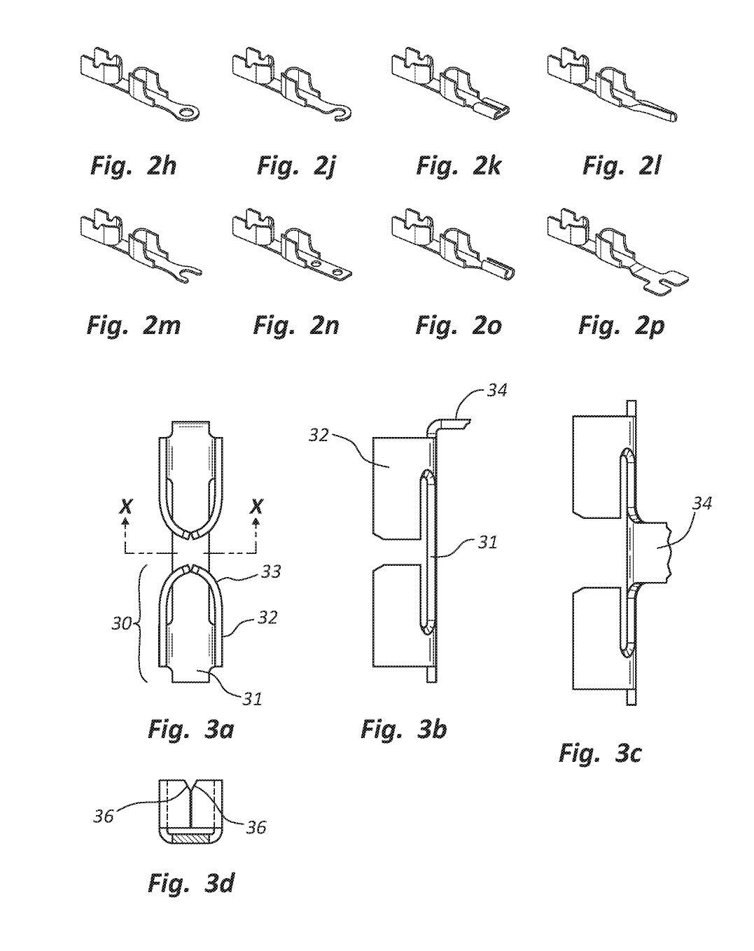

FIGS. 2a through 2g show common types of terminal carrier strips or pilot strips used to furnish a series of terminals for assembly into a connector. The terminal type shown in these figures is a quick-disconnect terminal [20] used in many industries including the automotive industry. The terminal includes a wire crimp section [21] where ears or similar features are folded over and compressed onto exposed conductors of a wire to make the electrical connection. The terminal also has a jacket crimp section [22] which is formed around and compressed onto the insulator or jacket of the wire being terminated. The jacket crimp withstands most if not all pulling forces, to prevent the electrical bond between the wire conductors and the wire crimp from being disturbed or from coming apart.

FIG. 2a shows a loose terminal. Loose terminals are usually handled in bulk using shaker plates or vibratory bowl feeders which orient and transport a line of these terminals for pick-up, wire termination and insertion into a connector or a connector headshell by automated tooling.

FIG. 2b shows the terminals carried by a pilot strip [23] which includes uniformly spaced holes so that a sprocket in automated assembly tooling can position and advance a terminal when needed for wire termination and assembly steps. Pilot strips usually have creases or notches so that the terminal can be readily shorn away from the pilot strip. Terminals carried on pilot strips can be wound and stored in bulk on large spools. In this view, the terminal is carried on its tail or jacket crimp section.

If a terminal is plated with another metal, shearing off a terminal from its carrier exposes the base metal. If the base material is corrosive in atmosphere or in its service environment, and plated to withstand corrosion, then these exposed areas will invite initial corrosion which can propagate within the metal and lead to eventual failure or disintegration of the terminal at its end of life.

FIG. 2c shows the terminals carried on a pilot strip [24] by the terminal end. Sometimes the shearing-off operation can create a beneficial lead-in lip for when the terminal is to be pushed onto its mating blade.

FIG. 2d shows the terminals carried on a first pilot strip [23] attached at the insulation crimp section of the terminal, and a second pilot strip [24] attached at the terminal end. The use of two or even more pilot strips increases the stability of the contacts or terminals when they are in storage on a bulk spool or in motion toward the point in a cable assembly operation where they are to be stripped off of their pilot strips. Additional stability in handling is required for terminals which have tightly tolerances geometric features where precise locational accuracies are required. Multiple parallel pilot strips achieve the required dimensional stability for these parts.

FIG. 2e shows the terminals carried by a center carrier strip [25.] Center carrier strips retain and locate terminals and their precision-formed geometries more robustly than tail carriers or terminal-end carriers. Pilot strips can also be called carriers.

FIG. 2f shows the terminals being carried on a tail carrier [23] and a center carrier [25.]

FIG. 2g shows the terminals being carried on a center carrier [25] and a terminal end carrier [24.]

FIG. 2h shows a strip of terminals [20] connected end to end. This line of terminals can be presented by application tooling to a wire strip and crimp tool which can sequentially terminate a plurality of wires for assembly onto spade contacts or insertion into a cable end or connector headshell.

FIGS. 2i through 2p show terminals using the inventive IDT wire cleat, and having various types of terminal ends used for connecting loose wires to binding terminal screws and the like and for installing into cable end head-shells and connector assemblies.

FIG. 2i shows a terminal having the inventive IDT cleat and a ring terminal.

FIG. 2j shows a terminal having the inventive IDT cleat and a hook terminal.

FIG. 2k shows a terminal having the inventive IDT cleat and a quick-disconnect terminal.

FIG. 2l shows a terminal having the inventive IDT cleat and a pin terminal. A pin terminal can be formed by rolling, a flat strip of metal into a tube and forming or coining the end into a hemispherical or ogive shape.

FIG. 2m shows a terminal having the inventive IDT cleat and a spade terminal.

FIG. 2n shows a terminal having the inventive IDT cleat and a lug terminal. The lug portion of the terminal may include one or more holes, or may include one or more concavities along its length.

FIG. 2o shows a terminal having the inventive IDT cleat and a snap plug terminal, which is also called a bullet terminal.

FIG. 2p shows a terminal having the inventive IDT cleat and a splitter terminal. Two quick-disconnect terminals can be connected to a single splitter terminal.

In summary, FIGS. 2a through 2h represent a female to flat tab interconnect wire to wire application where the termination sections on the strips shown are terminated to wire using conventional application tooling designs, such as high forces applied leveraged hand tools and bench tooling press equipment. The various termination design shown can be converted to the inventive IDT termination design sections as shown in FIGS. 2h through 2p.

FIGS. 3a through 3d show the features of the inventive IDT wire cleat, with FIG. 3d being a cross-section taken at a section line x-x defined in FIG. 3a.

FIG. 3a shows a top view of the inventive IDT wire cleat. It is an electrical contact comprising a flat strip section [31] and four cantilevers [30,] each cantilever having a straight section [32] and an arcuate section [33.] The cantilevers are arranged into first and second pairs with each pair having its two arcuate sections curving towards each other.

FIG. 3b is a side view projected from the view of FIG. 3a, and it is not explicitly aligned with FIG. 3a. In this view it is seen that a portion of straight section [32] of a cantilever is attached to the flat strip section [31.] The flat strip continues past the cleat to form a board-stake or solder-tail feature [34] which is broken off in this view. Feature [34] as a board-stake is usually used. to press-fit into a plated through-hole of a printed circuit board (PCA.) A good electrical bond can be made without soldering the stake into the plated hole. Solder tails are used to bond a contact or terminal to a land or via on the surface of a PCA. To prevent rocking and breaking off of board-stake or solder tail contacts, contact may have a plurality of these to anchor it securely to the PCA which also advantageously increases the current carrying capacity and mechanical robustness of the joint. In FIG. 3c this board-stake [34] originates at the side of the center strip at a point between the two cleats of the inventive IDT contact.

FIG. 3d is a cross-section view of the inventive IDT terminal design taken at the section line x-x shown in FIG. 3a. In this view it is seen that both tips of the arcuate sections of the cantilevers which form the cleat are formed so as to touch and pinch closed. In the embodiment shown, the arcuate sections of both cantilever beams have tips with chamfered edges [36,] but it is also within the scope of the invention for the tips to have a rounded edge. These features, whether a chamfer or a fillet, act as a lead-in for a jacketed wire being inserted from above down into region where the arcuate cantilever tips tough along their distal edges. Preferably, the arcuate sections of the tips are formed with a predetermined over-bend so that at their meeting edges a pinching preload exists. Downward movement of the jacketed wire transverse to and between the meeting edges of the mutually opposed cantilever tips spreads them apart under increased pinching force. The pinching force impinging on the wire jacket by means of a sharp edge, or the natural surface roughness and the serrated profile of the as-stamped or as-coined edge plus the relative movement of these edges and surfaces with respect to the jacket allow the cleat tips to lacerate the wire jacket and expose its interior metal conductors. The minimal contact area of the cleat tip edges concentrate the pinching force engineered by the preload, making electrical bonds between the terminal material and the conductors inside the wire and also crushing and swaging together the conductors caught in the pinch, thus achieving the previously explained benefits of deforming oxide-coated metals to expose new surfaces and immediately form gas-tight bonds among the wire conductors held at the pinch point and the bonds of the cleat tips which have bitten through the jacket, wiped away oxide films on the wire conductors, and maintain these bonds over the life of the terminal by means of these pinching forces.

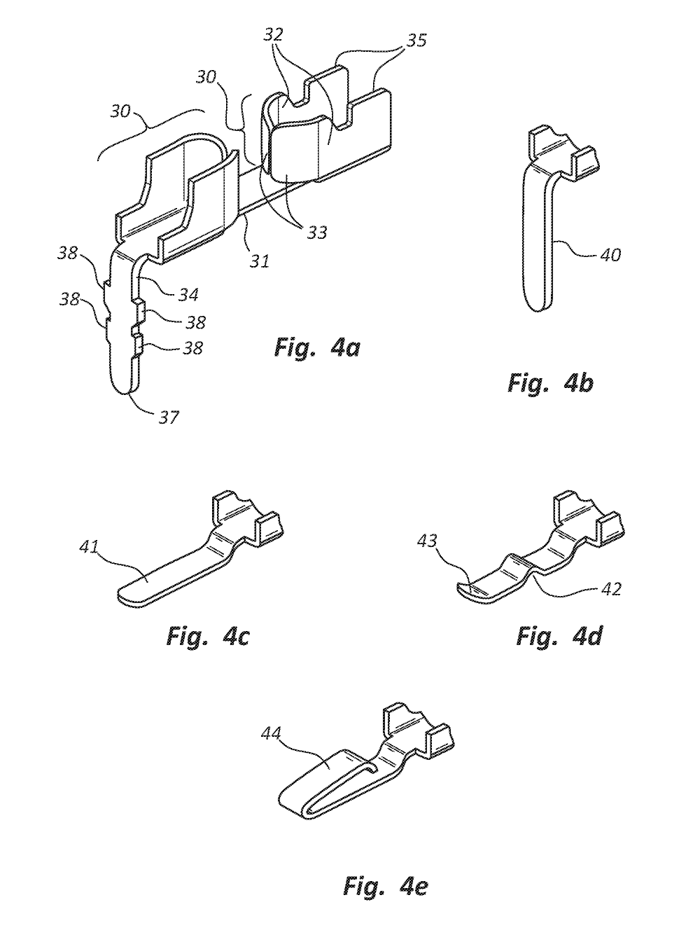

FIGS. 4a through 4d show optional board-stake and solder tail embodiments or the IDT wire cleat terminal all in accordance with the invention. As seen in FIG. 4a, the IDT portion of these types of terminals comprises two cleats, each formed by a pair of cantilevers. Each cantilever [30] has a straight section [32] and an arcuate section [33.] A portion of the straight section is attached to a flat strip section [31] of the terminal. A pair of substantially symmetrical cantilevers with their arcuate tips curving towards each other form a “cleat” of the invention, and in forming such a cleat sufficient curvature of the arcuate sections of the cantilevers is preferred so that their tips, which may include coined edges, abut closed with a preload pinching force.

Although a cleat made of a pair of substantially symmetrical beams is a preferred embodiment, asymmetrical cleat designs are also within the scope of the invention, such as would bias an inserted wire to a preferred side of the terminal if such asymmetry is desired.

Spaced apart from or aft of the straight section of the cleat, a pair of crimp ears [35] are provided to be used to crimp down upon the wire jacket and take up some or most of any unwanted mechanical forces applied to the wire, such as from tension, shock vibration, or thermal stresses. A crimp made onto the jacket at a point removed from the electrical bonds made by the terminal cleats of the invention also helps prevent twisting forces (torques) or angular displacement or other physical disturbance to the gas-tight connections made by the cleats, thus protecting the electrical integrity of the connection over the life of the devices wherein it is used. A crimp feature such as [35] is also called an “IDC,” or “Insulation displacement crimp.”

A crimp operation requires considerable crushing force delivered repeatably and reliably. A typical crimp operation can for a terminal of the design shown in FIG. 2a requires about 85 ksi of compression force from above, which will determine the pounds force required based on the area or number of mated lines being terminated. As a further example, the Bishop invention requires special hand tools (FIGS. 4A, 4B, 4C of '116,) to concentrate insertion force on the wires being terminated while carefully avoiding delicate terminal structures.

However, using cleat IDT terminals of the invention, wire insertion and termination can be achieved using less than 2½ pounds force per mated line. This reduced force requirement enables a new assembly method discussed further below. Tensile tests and other wire retention tests showed improved mechanical retention compared to the jacket crimp and wire crimp method used for terminals as seen in FIG. 2a.

FIG. 4a also shows contact with a tail [34] designed for insertion into a plated through hole of a printed circuit board (PCB.) The tail has a rounded or ogive tip [37] and one or more pairs of barbs [38] extending laterally from the axial direction of the tail to provide lead-in and initial centering as the contact is pressed into the hole. A trapezoidal lead-in also resides within the scope of the invention. Barbs further up on the contact tail extend wider than preceding barbs to present a progressively expanding engagement with the conductive plating inside the hole. Oxide films on the plating and on the contact are wiped or skived away during insertion, so that a reliable electrical bond is achieved.

FIG. 4b shows a different kind of tail portion [40] which can extend from the inventive IDT contact, having no barbs. This contact is soldered into a plated through hole and so the barbs of the previous design are omitted. FIG. 4c shows a contact tail [41] designed for anchoring the inventive contact onto a land, or a plated surface on a PCB. Soldering of the contact to its land can be accomplished manually or by machine, or by various reflow techniques known in the PCB assembly industry.

FIG. 4d shows a solder tail with improved adhesion to a land. The tail includes a hump section [42] and a raised end [43] resembling a ski tip. While solder is molten, these features draw in additional amounts by capillary action and surface tension effects of the melt. Besides the fillet of solder which collects around the periphery of this tail design, more solder is wicked under the hump and collects under the raised end, substantially increasing adhesion strength and resistance to tension or twisting in the wire inserted into the inventive IDT section of the contact.

FIG. 4e shows a leaf spring portion [44] of a terminal in accordance with the invention. Leaf spring contacts are used to pass electrical power or signals when a movable and conductive object is positioned over the leaf spring. Typical applications include interlock systems where a cover, lid, hood, or a safety screen must be closed in order for other powered equipment to operate safely. If the cover of safety screen is opened during operation of the equipment, loss of continuity is used to effect a shutdown of the equipment until a safe condition is restored. Other applications include delivering power to exchangeable or replaceable modules each having power pick-up contacts in a common location. Affixing a new module into place engages its contacts with the leaf spring terminals, allowing the module to be energized.

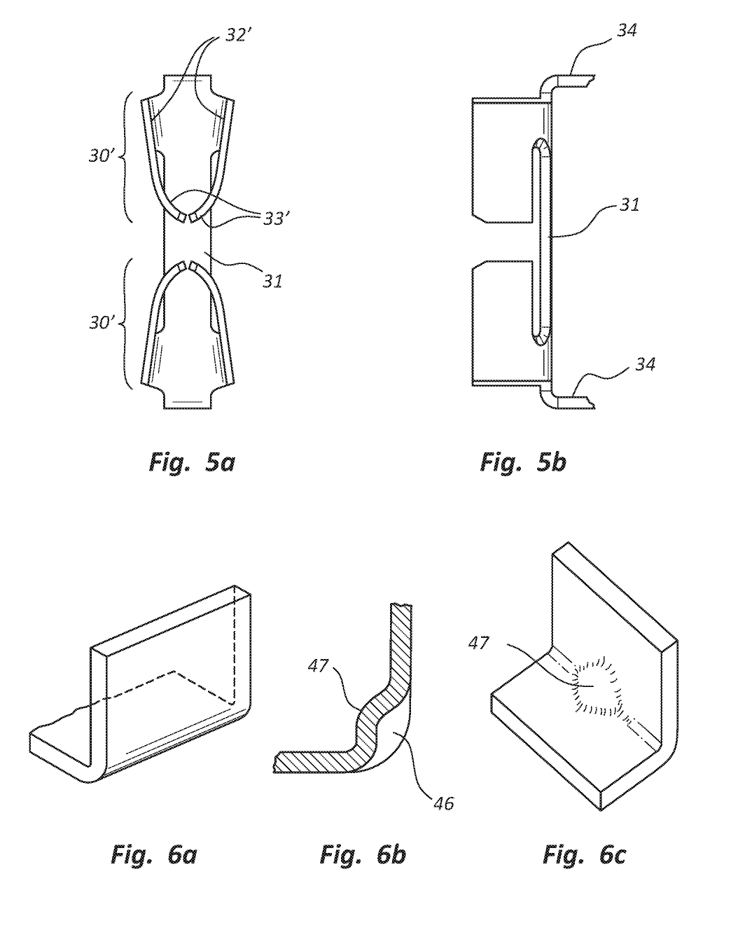

FIGS. 5a and 5b show a top and side view of an alternate embodiment of the inventive IDT wire cleat terminal section of a contact or terminal. In FIG. 5a, four cantilevers are paired off to form two wire cleats [30′] emerging from a flat center strip section [31.] Rather than all the straight sections being parallel to the strip section as in previous illustrations, in this embodiment the straight sections [32′] of the cantilevers of each wire cleat angle towards each other. The arcuate sections [33′] of each pair of cantilevers in each wire cleat curve towards each other and touch at their tips. By overbending the curved tips, a pinching preload can be established when the cantilevers are formed closed. Compared to the range of wire sizes able to be grasped by a single wire cleat design, the converging cantilevers shown in this figure widen the range of acceptable sizes by extending its lower limit. The converging cantilever design can handle roughly the same maximum wire gauge as a parallel cantilever of a similar design with the same feature dimensions, material composition and treatments, and material thickness, but it can successfully grasp and retain a smaller minimum wire gauge. One such wire cleat design can grip wires within the gauge range of 14 AWG-24 AWG in a single contact. “AWG” is an abbreviation for “American Wire Gauge.”

Because each wire cleat is formed by two cantilevers each having a straight section and an arcuate section, the cleat defines “front” where the tips of the two arcuate sections of the cantilever beams meet, and a “back” where the straight sections are attached to the flat strip section. Thus the two wire cleats of the terminal of FIG. 5a are oriented front to front, because the arcuate sections of the first pair of cant levers are oriented facing towards the arcuate sections of said second pair of cantilevers.

FIG. 5b shows the wire cleat design of FIG. 5a from the side, with the flat strip section [31] and partial portions of two tails [34] leading out the back end of each wire cleat. The cantilevers arranged into two pairs, first and a second, with each pair having two arcuate sections curving towards each other to form a pincer section. When the wire cleats face each other and are formed with enough preload at their closed tips so that they act as two pincers, and the pincer sections are located close to each other, and preferably as close as stamping and forming tooling can allow, the four beams of the two cleats act like a Chinese finger trap. The phrase “Chinese finger trap” has been allowed in patent specifications as recently issued as U.S. Pat. Nos. 9,970,503, and 9,988,748 and implies no cultural or ethnic disparagement.)

If the wire retained therein is pulled in either direction, the first wire cleat experiencing the tension as back to front will only relax slightly. The preload of the beams plus the additional pinching load created by the presence of the wire conductors forcing the beams apart will not be overcome by axial tension in the wire alone. However, the same tension also acts on the juxtaposed second wire cleat immediately opposite the first cleat. The edges of the beam tips already engaged to the wire bite into the wire even harder and lock it in place. The symmetrically opposed cantilevers of a wire cleat withstanding a front to back tensile load in the wire it is grasping cooperate like the pairs of straight and curved sections of a Gothic arch and can support substantial compression forces before a buckling load is reached.

FIGS. 6a, 6b, and 6c illustrate a stiffening pocket or rib embossed or indented into an angle or channel portion of a stamped and formed contact in accordance with the invention. The dihedral of an angle or a channel as depicted in FIG. 6a is more resistant to downward bending than a flat strip of material, because of its greatly increased section modulus contributing to the sectional strength. However, some bending conditions allow the angle of such a channel section to unfold, reducing its sectional strength and precipitating a buckling failure of such a component. Sectional strength can be preserved by including stiffening ribs that tie one leg of the angle channel to the other to prevent the angle from unfolding at its crease. In small stamped and formed sheetmetal work such as in the manufacture of electrical terminals, fully formed stiffening ribs are often impractical to create.

As seen in cross-section FIG. 6b, substantial increases in strength against buckling can be achieved by indenting a pocket [46] from the anhedral side of the folded edge of a channel and allowing an inward bulge [47] or boss to form within the dihedral side of the channel. The additional strength gained not in section modulus and resistance to unfolding of the crease of the channel section, but also from work hardening of the material local to this feature. FIG. 6c. depicts the boss [47] as seen from the inside or dihedral side of the channel section.

Another way of describing this insulation displacement termination (IDT) connector is that it has an electrical conducting structure that includes closed dual, opposed IDT semi-circular displacement sections with whereby each IDT semi-circular displacement section exerts a closing spring force and comprises a notched lead-in to a slit to accommodate an inserted wire and expand apart when inserting the wire.

The semi-circular displacement sections use cut-through-insulation displacement action to cut through wire insulation as a wire is slid down into a trench formed by walls of the IDT. The semi-circular displacement sections pinch and establish a contact with conductors of the wire.

The walls of the IDT extend back from the semi-circular displacement sections and include a coined embossed point to add strength at those walls. The coined embossed points are formed or indented on each side of the trench near the semi-circular displacement sections that comprise that portion of the wire cleat, which is where the straight section of the cantilever beam attaches to the flat strip section of the contact.

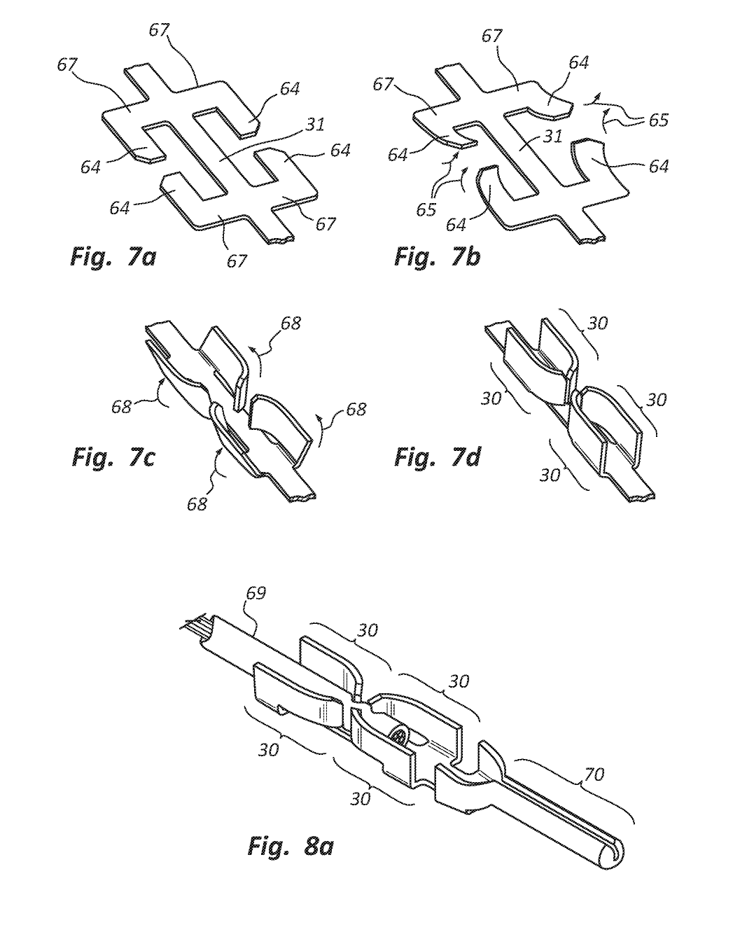

FIGS. 7a through 7d show the progressive steps in forming the inventive IDT portion of a contact or terminal in accordance with the invention. FIG. 7a shows the flat center strip section [31] with four beams emanating laterally from the center strip. The roots [67] of those beams will become the supports for the cantilever beams comprising the two wire cleats of the inventive terminal. The outlines of the cantilevers have been defined by previous punching operations not shown here. The strips of material [64] will be formed up to become the arcuate sections of the cantilever beams. Although here they are shown with rounded tips, alternate designs having squared-off tips with either a chamfer or a fillet corner to produce the lead-in features [36 of FIG. 3d] are also within the scope of the invention.

FIG. 7b shows the strip after a step of forming up or curling up the four arcuate sections [64] of the cantilever beams. Coining operations of the beam tips can sharpen the edges of the tips for better laceration of wire jackets and higher contact normal forces due to reduced contact areas, and can also impress channels or negatively or positively curved surfaces along the length of the cantilever beams to be formed. This stage is also where the degree and extent of curvature of the arcuate sections of the cantilevers can be controlled to establish a predetermined preload force when the beam pairs are formed up into a wire cleat. Forming direction arrows [65] in this figure illustrate the curling up of material to form the cantilever beam tips.

After forming the arcuate sections of the beams and their tip geometries, FIG. 7c shows four fold-up operations where each cantilever beam is bent up to form wire cleats which are opposed pairs of beams with their tips abutting and holding each pair of beams closed by means of a pinching preload established during this operation. The fold-up operations are illustrated by arrows [68.] In this figure the closure of the pairs of beam tips is shown not yet complete.

FIG. 7d shows an embodiment of the IDT features in a completed form. Each cantilever beam [30] is seen with its straight section connected to the center strip, and formed into pairs of beams with their tips abutted closed, to comprised a pair of wire cleats having an established preload pinching force. The two wire cleats of the IDT section of a contact or terminal in accordance with the invention are oriented to face each other.

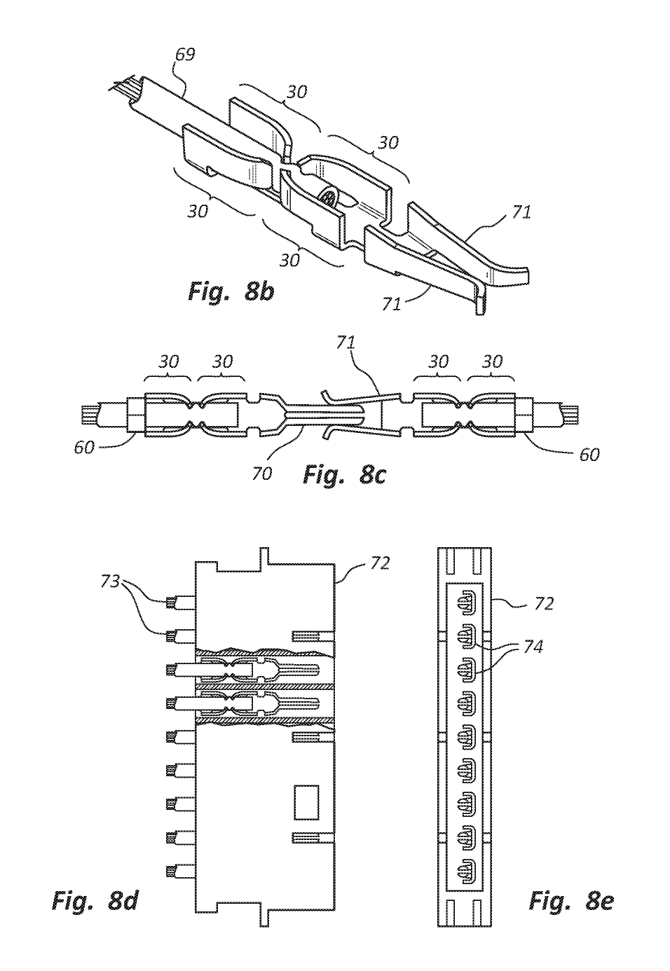

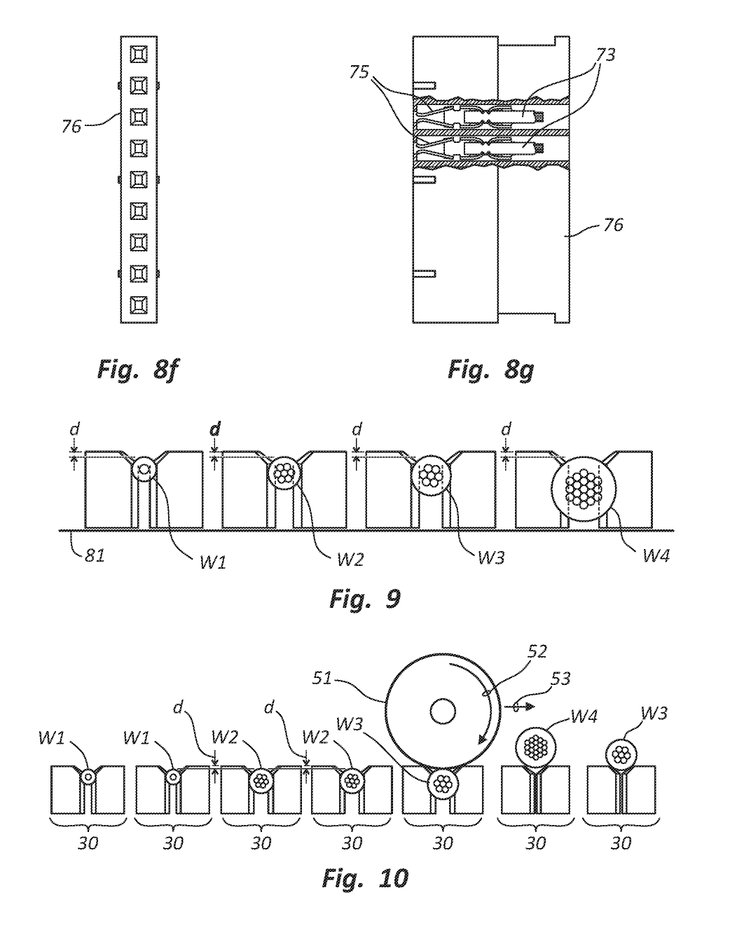

FIG. 8a shows an alternate embodiment of a wire cleat IDT terminal in accordance with the invention. The wire jacket [69] has been lacerated and the two wire cleats have bitten into the conductors of the wire, pinching them together to form two redundant gas tight connections. The wire jacket [69] has been lacerated in two places by the tips of the cantilever beams of the wire cleats of the invention. The end of the wire is a simple cut with no further wire end preparations required. There is no stripping or trimming or tinning of leads or other wire preparations required. The jacketed wire is simply pressed downward into the cleats of the inventive IDT terminating section of the terminal shown. Redundant connections in a terminal design improve reliability, robustness in challenging environments, and long service life.

The four cantilever beams [30] are arranged in the preferred orientation of two wire cleats facing each other. Each wire cleat comprises a pair of cantilever beams [30.] The center strip section continues past the IDT section and is rolled up to form a split pin [70.] The IDT terminal is shown with a wire installed into its wire cleats. It is also possible and within the scope of the invention make the two wire cleats facing away from each other, that is, the arcuate sections of a first pair of cantilevers are oriented facing away from the arcuate sections of a second pair of cantilevers.

FIG. 8b shows an inventive IDT terminal in accordance with the invention which is complementary to the pin terminal shown in FIG. 8a. As before, the wire jacket [69] has been lacerated and the two wire cleats have bitten into the conductors of the wire, pinching them together to form two redundant gas tight connections. The four cantilever beams [30] are arranged in the preferred orientation of two wire cleats facing each other. The terminal includes two tapered beams [71] having flared tips which provide lead in for receiving the split pins or rolled pins of the pin terminal of FIG. 8a. A pair of tapered beams oriented and formed as shown in this figure is also called a duck-bill contact.

FIG. 8c shows a split [70] terminal and a first wire installed into the inventive IDT section of the terminal with its cantilevers [30,] mated to a duck-bill [71] terminal with a wire installed into the inventive IDT section of the terminal. Both the male and female terminals shown in this figure include insulation crimps [60] which have been crimped over the wire jacket for substantially improved wore retention. This arrangement is often called a “mated line” or “mated pair,” especially when calculating cost estimates. Large harnesses are often compared by the net cost of the entire cable harness assembly divided by the number of mated pairs in the assembly when installed.

FIGS. 8d and 8e show a top view and end view of a male cable headshell including wires [73] mated to the inventive IDT pin terminals. An insulator housing [72] receives a plurality of pin terminals and presents one or more rows of pins. Such a connector is also called a header or a plug. In this design the male pins [74] reside within a shroud or frame to protect them from damage in handling or installation. A partial cut-away view of the insulator in FIG. 8d reveals two male pin terminals.

A unique advantage of the inventive terminal design is that the wires leading into the connector do not have to be all the same size. Thus one connector housing or cable end can present sets of terminated wires sized for different applications, such as power, signaling or heating. Each single IDT terminal design shown here, being capable of physically gripping to and electrically bonding to many different wire sizes, allows the creation of a wide range of mission specific and customizable cable head-shells for a wide range of industrial applications. The terminals shown may also include an insulation crimp section [35 of FIG. 4a] for additional robustness in harsher conditions.

FIGS. 8f and 8g show a top view and end view of a female cable headshell [76] including wires [73] mated to the inventive IDT duck-bill terminals [75] for receiving pins of the male connector shown in FIGS. 8d and 8e. This female connector shares all the benefits of the inventive IDT terminals shown previously in the male connector.

FIG. 9 shows a set of the inventive IDT wire cleats, all of the same size, installed onto a device [81] which can be a PCB, or connector headshell. Each IDT wire cleat receives and connects to a wire of a different size [W1, W2, W3, W4.] The phantom lines show where the tips of the cantilever beams of the wire cleats have bitten through the wire jacket and have clamped onto the conducive strands of the wire. [W1] is a small, solid wire having a single strand. Proper insertion depth is shown by dimension ‘d’ is the same for all wire sizes, so the same insertion tooling can be used for all wire sizes and advantageously allows mixed wire-size termination available within a single headshell. The invention simplifies and reduces they types of tooling kept on hand at a cable assembly work station, and reduces inventory cost, process complexity, time spent for tooling changeovers, and reduces the opportunities for error and rework or scrapped material.

FIG. 10 shows a new means of wire installation into the inventive IDT wire cleats, using a wheel or a roller [51.] The rolling direction is shown by arrow [52] and the translation direction is shown by arrow [53.] Wires having mixed wire gauges [W1, W2, W3, W4] are lain atop the wire cleats of the inventive terminals or contacts. No special wire end preparations such as stripping, tinning, or squared-off cuts are required, so simpler and cheaper wire handling machinery can be used. The roller passes across a linear array of terminals and pushes them all into the predetermined insertion depth ‘d’ as shown. Insertion depth is measured from the top horizontal tangent point on a wire jacket. The cleat jaws open to different widths as they receive wires of different sizes, and they lacerate the wire jackets, skive off oxide films on the wire conductors and bite onto freshly exposed metal to make a reliable and durable electronic bond between the wire and the terminal or contact. The capability of a terminal of the invention to accept a wide variety of wire sizes and styles, plus the substantially reduced insertion force of terminals of the invention allow a single wheel to be used to produce many different cable harnesses without requiring extra time to change over equipment or application specific tooling Also, no hand-driven insertion tools are required. Thus FIG. 10 introduces “roller crimp application tooling,” a new idea to terminate side feed terminal strips.

While certain features and aspects have been described with respect to exemplary embodiments, one skilled in the art will recognize that numerous modifications are possible. Also, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Furthermore, the procedures described with respect to one method or process may be incorporated within other described methods or processes; likewise, system components described according to a particular structural configuration and/or with respect to one system may be organized in alternative structural configurations and/or incorporated within other described systems. Hence, while various embodiments are described with or without certain features for ease of description and to illustrate exemplary aspects of those embodiments, the various components and/or features described herein with respect to a particular embodiment can be substituted, added, and/or subtracted from among other described embodiments, unless the context dictates otherwise.

Consequently and in summary, although many exemplary embodiments are described above, it will be appreciated that the invention is intended to cover all modifications and equivalents within the scope of the following claims.

What is claimed is:

1. A electrical contact comprising
a flat strip section,
four cantilevers, each having a straight section and an arcuate section,
with a portion of each of said straight section attached to said flat strip section,
said cantilevers arranged into first and second pairs, with each pair having its two arcuate sections curving towards each other.

2. The electrical contact of claim 1, wherein an arcuate section includes a tip having a chamfered edge.

3. The electrical contact of claim 1, wherein an arcuate section includes a tip having a rounded edge.

4. The electrical contact of claim 1, wherein said arcuate sections of said first pair of cantilevers are oriented facing towards the arcuate sections of said second pair of cantilevers.

5. The electrical contact of claim 1, wherein said arcuate sections of said first pair of cantilevers are oriented facing away from the arcuate sections of said second pair of cantilevers.

6. The electrical contact of claim 1, wherein all of said straight sections of said cantilevers are parallel to said strip section.

7. The electrical contact of claim 1, wherein tips of said arcuate sections of a pair of cantilevers touch.

8. The electrical contact of claim 7, wherein said tips of said arcuate sections of a pair of cantilevers are formed closed with a pinching preload.

9. An electrical contact comprising
a flat strip section,
first and second wire cleats each formed by two cantilevers, each cantilever having a straight section and an arcuate section,
with a portion of each of said straight section attached to said flat strip section,
said cantilevers arranged into first and second pairs, with each pair having its two arcuate sections curving towards each other.

10. The electrical contact of claim 9, wherein an arcuate section includes a tip having a chamfered edge.

11. The insulation displacement termination (IDT) connector of claim 9, wherein said portion where a straight section attaches to said flat strip section includes a coined embossed point to add strength to said portion.

12. An insulation displacement termination (IDT) connector, comprising:
an electrical conducting structure that includes closed dual, opposed IDT semi-circular displacement sections;
whereby each IDT semi-circular displacement section exerts a closing spring force and comprises a notched lead-in to a slit to accommodate an inserted wire and expand apart when inserting said wire;
wherein the semi-circular displacement sections use cut-through-insulation displacement to cut through wire insulation as a wire is slid down into a trench formed by walls of the IDT, and establish a contact with conductors of said wire.

13. The insulation displacement termination (IDT) connector of claim 12,
wherein said walls extend back from said IDT semi-circular displacement sections and include a coined embossed point to add strength to said walls of said IDT on each side of the formed trench near said semi-circular displacement sections.
